(19) United States
(12) Patent Application Publication
(10) Pub. No.: US 2022/0350833 A1
(43) Pub. Date: Nov. 3, 2022

(54) SYSTEM AND METHOD FOR CREATING, MANAGING, AND PROVIDING A DELAYED REVEAL AND DISPLAY OF ITEMS IN PACKS OF 3D DIGITAL COLLECTIBLES

(71) Applicant: Dapper Labs Inc., Vancouver (CA)

(72) Inventors: Denise Cascelli SCHWENCK BISMARQUE, Vancouver (CA); Jack Robert BONNINGTON, Vancouver (CA); Derrick Evan PELLETIER, Vancouver (CA); Eric Yu-Yin LIN, Surrey (CA)

(73) Assignee: Dapper Labs Inc., Vancouver (CA)

(21) Appl. No.: 17/306,492

(22) Filed: May 3, 2021

(51) Int. Cl. G06F 16/44; G06F 3/0481; G06F 16/438; G06T 15/80

(52) U.S. Cl. CPC G06F 16/444; G06F 3/04817; G06F 3/04815; G06F 16/438; G06T 15/80

(57) ABSTRACT

A system and method for creating, managing, and displaying packs of 3D digital collectibles comprising a virtual, three dimensional, n-sided structure including a digital media file or set of digital media files representing an event rendered on a representation of a first surface thereof, and data relating to the event rendered on at least a second surface thereof, where the digital media file may be a video clip of the event that can be played automatically via a media player associated with the display. The system may provide a graphical user interface that displays a set of user tools to interact with the packs of 3D digital collectibles and to display the 3D digital collectibles of the packs and serially play the digital media files of the 3D digital collectibles.

### FIELD OF THE INVENTION

The field of the invention relates to a system and method for creating, managing, providing a delayed reveal and display of items in packs of 3D digital collectibles of sports plays or other events.

### BACKGROUND OF THE INVENTION

Physical collectibles, such as baseball cards, are known. Recently, digital collectibles have also been developed. However, the technology related to such digital collectibles is limited. For example, known digital collectibles are static, two-dimensional, images. These and other technical limitations and drawbacks exist with known collectibles.

### BRIEF SUMMARY OF THE INVENTION

According to an aspect of the invention, there is provided a system and method for creating, managing, providing a delayed reveal and display of items in packs of 3D digital collectibles of sports plays or other events and a set of user tools to interact with the packs of 3D digital collectibles. The 3D digital collectible may include a 3D virtual display element comprising a virtual, three dimensional, n-sided structure including a digital media file or set of digital media files representing an event rendered on a representation of a first surface thereof, and data relating to the event rendered on a second surface thereof, where the digital media file may be a video clip of the event that can be played automatically via a media player associated with the display.

In some embodiments, the packs include a set of n 3D digital collectibles, and provide some indication of their contents without revealing the specific n 3D digital collectibles or corresponding digital media files that form the pack. In response to the selection or opening of the pack by the user, the system displays n icons corresponding to the n 3D digital collectibles, but that do not reveal the specific 3D digital collectibles that form the pack. In response to the selection of one of the n icons, the system displays the 3D digital collectible, and may play the associated digital media file.

The above stated aspects, as well as other aspects, features and advantages of the invention will become clear to those skilled in the art upon review of the following description. It should be understood that the description and specific examples, while describing several exemplary embodiments, are intended for purposes of illustration only and are not intended to limit the scope of the disclosure.

### BRIEF DESCRIPTION OF THE DRAWINGS

The above and/or other aspects of the invention will be more apparent by describing in detail exemplary embodiments of the invention with reference to the accompanying drawings, in which:

FIGS. 1a-1e show a 3D digital collectible according to some embodiments of the invention;

FIG. 2 shows aspects of a pack of 3D digital collectibles according to some embodiments of the invention;

FIGS. 3a-3c show aspects of the display of contents of packs of 3D digital collectibles according to some embodiments of the invention; and

FIG. 4 shows aspects of a 3D digital collectible management system according to some embodiments of the invention.

### DETAILED DESCRIPTION OF THE INVENTION

Exemplary embodiments of the invention will now be described below by reference to the attached Figures. The described exemplary embodiments are intended to assist the understanding of the invention and are not intended to limit the scope of the invention in any way. Like reference numerals refer to like elements throughout. The examples are provided in connection with a sports event by way of example only. The platform may be used with other events including the other types of events referenced herein and other types of events.

The 3D Digital Collectible

Aspects of various types of events may include important portions which can be captured (as digital media files or other forms of capture). Such digital media files may include videos, images, sounds, and or other forms of capture that record a particular event during an experience. For example, in relation to sports, an event can be a particular play, such as a dunk in a basketball game, a goal in a soccer match, or a catch in baseball. In such examples, the event may be captured as a video, audio and/or other form of highlight, including from one or more perspective views, as a digital media file or files. The event can be of different durations appropriate to memorialize the event. An event may be part of a live-action experience, such as a sporting match or play, or a scripted or pre-recorded experience, such as a movie.

In an exemplary embodiment, a 3D digital collectible may be defined, generated, and rendered. The 3D digital collectible may include a digital media file (e.g., a video highlight clip) or a set of digital media files (e.g., different perspectives of the same event or a series of files before, during and/or after the event) representing an event, along with data relating to the event. An event may include all or any identifiable portion of an experience.

The 3D digital collectible may be a virtual, three dimensional n-sided structure (where n is preferably greater than 3), where the n-surfaces may be configured to form an n-sided 3D shape, such as a cube, pyramid, octagon, or other 3D shape. One or more of the surfaces may display one or more digital media files, or portions of such digital media files, and/or one or more portions of data (or other content) in a defined relationship stored in memory such that a particular side may display a digital media file or files, or portions thereof, a portion or portions of data, other content or combinations thereof.

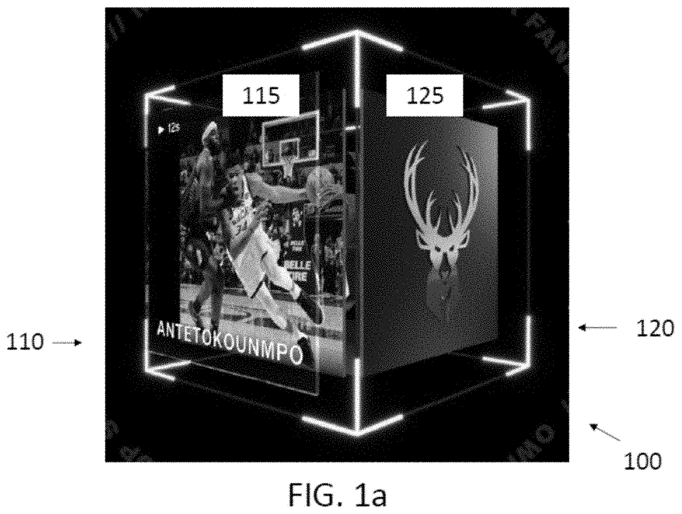

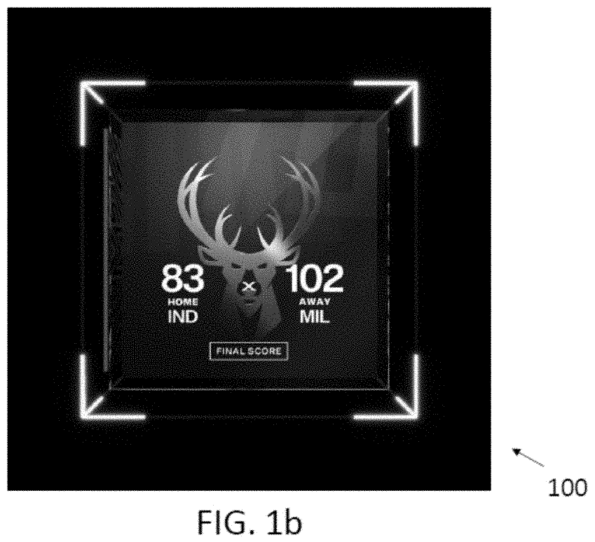

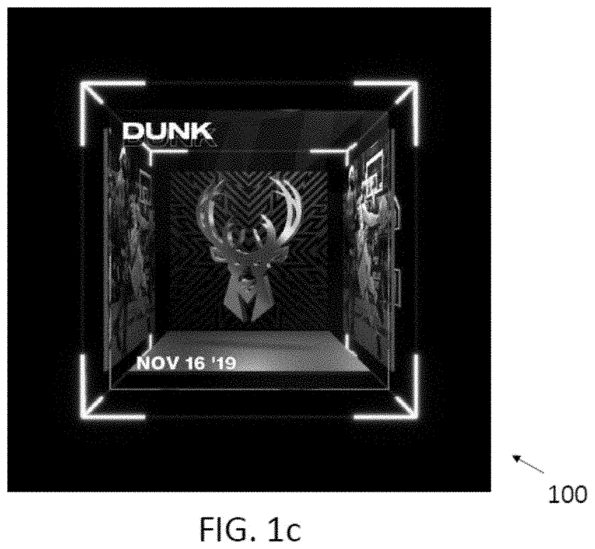

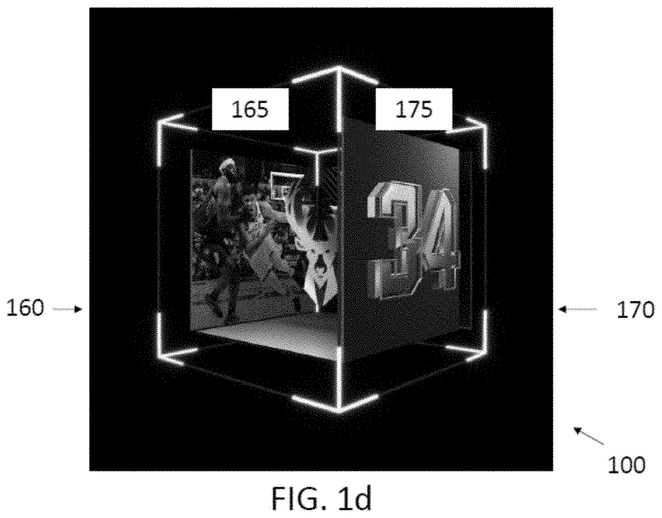

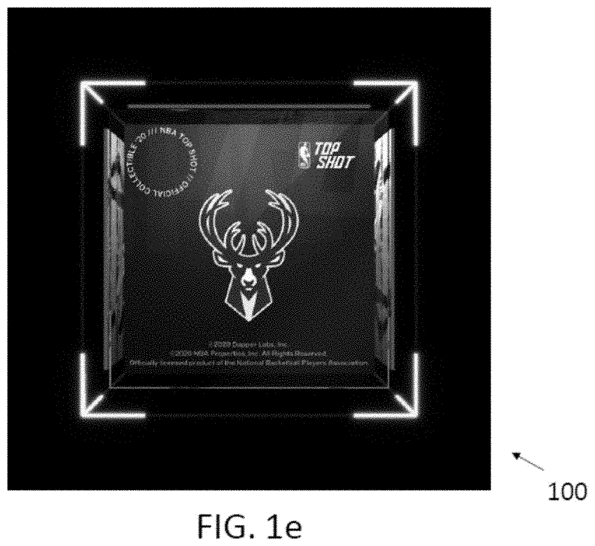

In the exemplary embodiment shown in FIG. 1a, a 3D digital collectible 100 is cube-shaped with six surfaces. In the perspective view of FIG. 1a, first surface 110 and second surface 120 are visible. First surface 110 has a digital media file 115, in this case a video clip. Second surface 120 has data 125, in this case the logo of the team of which a player in digital media file 115 is a member. FIGS. 1B-1e show further views of 3D digital collectible 100. In FIG. 1B, another surface of 3D digital collectible 100 is shown. Thus surface includes data, in this case a team logo and score related to the event to which the 3D collectible is related. In FIG. 1c, another surface of 3D digital collectible 100 is shown. This surface also includes data, in this case a team logo and a date and description of the event to which the 3D digital collectible is related. In FIG. 1d, another perspective view of 3D digital collectible 100 is shown. In this view, a surface 165 with different representation of a team logo is provided, such that it appears within collectible 100, along with a surface 175 with a number of the player shown in the video clip on surface 110. In this embodiment, the rear of surface 110 showing digital media file 115 may be seen through 3D digital collectible 100. In FIG. 1e, another surface of 3D digital collectible 100 with a team logo and copyright and system information is shown.

In various embodiments, the 3D digital collectible may be statically displayed in its virtual environment (e.g. on a computer display screen), or may be dynamically displayed, such that it is rotatable to display one or more of the surfaces and the associated content (e.g., a digital media file and/or data) assigned to that surface. Such dynamic display may be by way of interactions with a user, in response to a predefined movement or movements (e.g., via a script or other computer code), or combinations thereof.

The digital media file may be any type of media, including still images, video, audio, and/or other media, or combinations of such media. Digital media files may include a single view, audio track, or other recording, or composites of multiple views, audio tracks, or other recordings, such as a composite video showing different perspectives of the event, such as different camera views of a sports play or other event. The digital media files may also include multiple views, audio tracks, or other recordings of the event from different perspectives, times, or durations that may be played sequentially and/or in other order. Such sequential play can be implemented by user interactions with a list of the multiple views, audio tracks, or other recordings, by accessing the multiple views, audio tracks, or other recordings in accordance with a script, or by stitching together the multiple views, audio tracks, or other recordings into a single digital media file. In this regard the composite or sequential digital media files may include different types of files (e.g., they may include one or more of a video file, audio file, or other recording). Portions of a single digital media file may also be identified, separated, and used as individual digital media files in the manner described herein (e.g., a digital media file may be sequentially divided with different portions considered as different digital media files). For example, a single digital media file may be sequentially divided and provided on different surfaces of the 3D digital collectible.

The data relating to the event may include event data that describes the event itself. Using a sporting match as an example, event data may include such information as the player's name, the type of play (such as a dunk, block, or steal), the date and/or time of the event, and other event data. A second type of data may include actor data relating to the person captured in the event. Again using a sporting match as an example, actor data may include such information as the player's statistics, measurements, position, age, experience, hometown, college, draft selection, or other actor (or actors) data. A third type of data may include context data that describes additional information about the context of the event. Again using a sporting match as an example, context data may include the teams that are playing, the location of the game, the score of the game, the sports league, the sports season, and context data. The digital media file and any related data and/or other content may be collectively referred to as content.

Further exemplary embodiments of context data include information related to an entertainment experience from which the event is drawn, situational information related to the entertainment experience, the subject of the experience, and/or information related to the digital media file. For example, context data related to a sporting match may include the number of teams, the box score, game statistics, seasonal averages for the player, media about the game, and other context data. In the sporting match example, the context data may relate to one or more players or teams that are represented in a digital media file.

The various forms of data may be associated with a digital media file in any known manner, such as by tags, attributes, metadata, pointers and/or other associations. Data may be stored in a data structure in one or more databases. The data structures may link an event with media files, data, content and metadata. The event and/or digital media file can be searched based on information associated with the event or the digital media file.

Data may also include metadata. Metadata may include information specified in connection with the creation of the 3D digital collectible that specifies attributes of the digital collectible. The attributes may include the configuration of the digital collectible (e.g. the number of sides) the manner in which content should be displayed, such as what content should be displayed, where the content should be displayed (e.g., on which surface of the n-shape), and how the content should be displayed, including in relation to other content. Other attributes of the digital collectible may be used.

Metadata may also include information associated with the uniqueness or classification of the scarcity of the digital collectible. For example, a collectible may be a one of a kind instance of an event or there may be a predetermined number of instances or other methods for determining a number of instances. In any case, the digital collectible may be identified by a serial number or other unique value that uniquely identifies a particular 3D digital collectible, along with a unique identifier for the instance (e.g., 1 of 1 or 1 of 10, etc.) as necessary.

Scarcity may be represented by a classification based on the number of instances. For example, more than 1000 instances may be a first classification, 500-1000 may be another classification, 100-500 may be another classification, and so on. Other numbers may be used to categorize scarcity classifications. The uniqueness or scarcity (e.g., the number of instances) can be set for an individual 3D digital collectible as part of the initial creation process in defining the collectible. The metadata may include data that dictates how the 3D digital collectible is rendered for display based on the scarcity of the 3D digital collectible. For example, data relating to the uniqueness or scarcity of the 3D digital collectible can be displayed on the collectible, or other displayed features of the 3D digital collectible may relate to rarity or scarcity, such as the colors, shading, material, textures, lighting and/or visual display indicators that depict a scarcity classification.

The digital media file and data may also be created based on another digital media file or data. For example, a digital media file including a graphic and/or sound may be generated based on a digital media file including a video. As such, 3D digital collectibles can include one or more related digital media files and data.

System

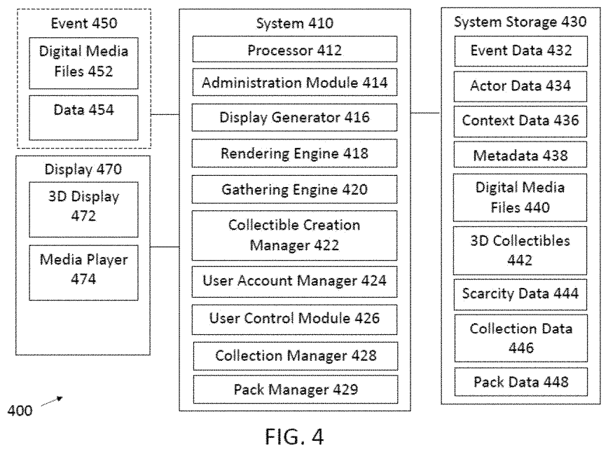

A platform 400 for creating, generating, managing, storing, rendering, and displaying 3D digital collectibles according to an exemplary embodiment of the invention is shown in FIG. 4. FIG. 4 shows system 410 with various modules and engines for defining, generating, and rendering a 3D digital collectible, system storage 430 for storing data, digital media files, 3D collectibles, and collection information, and display 470 for displaying the 3D digital collectible to a user.

System 410 may include a computer server including a processor 412 programmed with computer instructions including an administration module 414, a display generator 416, a rendering engine 418, a gathering engine 420, a collectible creation manager 422, a user account manager 424, a user control module 426, and a collection manager 428. Platform 400 may also include a display 470 with 3D display 472 and media player 474. Platform 400 may also include an associated computer memory or system storage 430 that stores a data structure comprising event data 432, actor data 434, context data 436, metadata 438, digital media files 440. 3D collectibles 442, scarcity data 444, and collection data 446, associated data/content, and particular association(s) therebetween, including rules that define what is to be displayed on the surfaces of the 3D digital collectible. The components of the systems may be co-located or distributed.

Platform 400 may include tools to define and create a 3D digital collectible, and store and manage digital collectibles, as described in more detail in a U.S. application filed Apr. 13, 2021 as Attorney Docket No. 77HN-332439, hereby incorporated by reference in its entirety.

Platform 400 may also include tools to display 3D digital collectibles, such as display generator 416 and rendering engine 418 for generating graphical user interfaces (GUIs) and rendering a 3D digital collectible for display therein to a user via 3D display 472 on display 470. For example, the 3D digital collectible (e.g. the digital media file and data) may be configured to be displayed as a 3D display element. The digital collectible can be represented as, or otherwise include, the 3D display element. The 3D display element can be in a virtual 3D graphical interface. The 3D display element can have n-surfaces which are combined together into an n-sided shape, (cube, sphere, pyramid, octagon, etc.). Each face or side of the of the n-sided shape can display at least one of the aforementioned digital media and/or data types. Each face or side of the n-sided shape can have associated digital media and/or context data of a specific type (for example, belonging to a specific classification of media, such as images, video, text, sound for playback, etc.).

The display generator 416 and rendering engine 618 may generate a GUI on display 470, the representation of the 3D digital collectible, and a media player for playing the digital media file(s) included with the 3D digital collectible based on scripted or user selected commands. The GUI may be configured to display the 3D digital collectible as the virtual, three dimensional n-sided structure discussed above. The display may be pre-rendered or rendered in real-time as it is being displayed. The 3D digital collectible may be rendered and displayed in any orientation, such as the perspective and plan views of FIGS. 1a-1e, may be stationary in one view, or may change orientation between views (e.g., rotate, translate, etc.) either automatically based on elapsed time, in reaction to a user interaction (e.g., mouse click, scroll bar movement, or touch interface), or both.

Packs

In an exemplary embodiment, 3D digital collectibles can be provided to users (e.g., by sale or trade) in a digital pack, or set. These packs may be digitally rendered on a graphical user interface in a manner similar to that of the 3D digital collectibles discussed above. The packs may be configured by a system administrator and in accordance with a set of rules and data parameters.

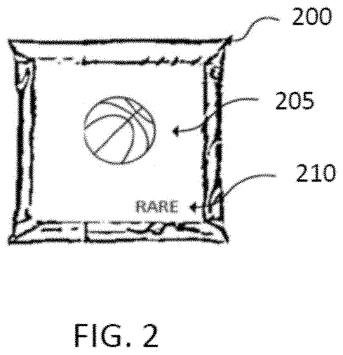

FIG. 2 depicts an exemplary embodiment of a pack 200, as it may be displayed on a GUI. The pack 200 may be rendered in any fashion that would represent a set of 3D digital collectibles to a user. In this embodiment, pack 200 is rendered to resemble a physical pack of trading cards. Pack 200 includes graphical data 205 or other data, including event, context and/or metadata 210 associated to the collectibles in the pack. For example, pack 200 can include representations of the dates of the events of its constituent digital collectibles, the actors in the events, and the like. Pack 200 may also include an indication of the number of 3D digital collectibles contained therein. However, according to some embodiments, the individual items of the pack may not be revealed at this level of display.

Pack 200 may also include a scarcity value 210 that indicates a scarcity classification of one or more of the 3D digital collectibles contained in the pack 200. In this embodiment, the scarcity value 210 is “rare,” which indicates that at least one of the 3D digital collectibles of pack 200 is a “rare” 3D digital collectible. Scarcity values are described in more detail in a U.S. application filed Apr. 30, 2021 as Attorney Docket No. 77HN-333419, titled “System And Method For Creating, Managing, And Displaying Limited Edition, Serialized 3D Digital Collectibles With Visual Indicators Of Rarity Classifications”, hereby incorporated by reference in its entirety.

Pack 200 may also be rendered with one or more colors, shading, lighting, and/or textures. The colors, shading, material, textures, and/or lighting can correspond to values of the data, such as event data, context data, and/or metadata (e.g. rarity/scarcity) for one or more digital collectibles within the pack 200. In exemplary embodiments, packs may be rendered as shiny or holographic.

In some embodiments, a user seeking to acquire a pack 200 may not be permitted to see the specific 3D digital collectibles that are part of pack 200 before it is purchased. In other embodiments, some amount of data relating to the pack, such as event data, context data, or metadata corresponding to the pack may be shared. For example, the scarcity value of a pack or at least one of the 3D digital collectibles may be indicated (e.g., legendary, rare, or common).

In some embodiments, the pack can be visually represented as user-manipulatable packaging icon (e.g. square, rectangular other shape) that can be digitally “opened.” For example, the pack can be “opened” by user interactions, such as by clicking a button, virtually tearing the pack, or other appropriate manipulation.

A GUI may display a separate icon for each of the packs associated with the user account. After acquisition and opening by a user, an icon representing each of the 3D digital collectibles associated with the pack may be displayed in a grid, carousel, or other arrangement for viewing. The manner in which the 3D digital collectibles icons spread out of the pack (i.e. a visual representation thereof) may depend on one or more values of related data, such as event data, context data, or metadata. The display may be similar to that of a collection as described in more detail in a U.S. application filed Apr. 30, 2021 as Attorney Docket No. 77HN-333420, titled “System And Method For Creating, Managing, And Displaying User Owned Collections Of 3D Digital Collectibles,” hereby incorporated by reference in its entirety.

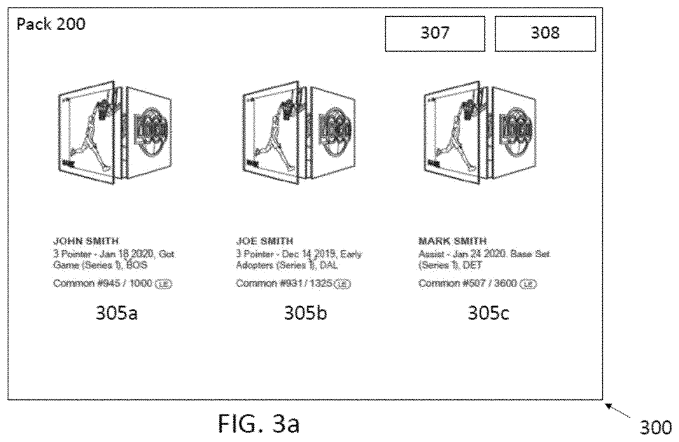

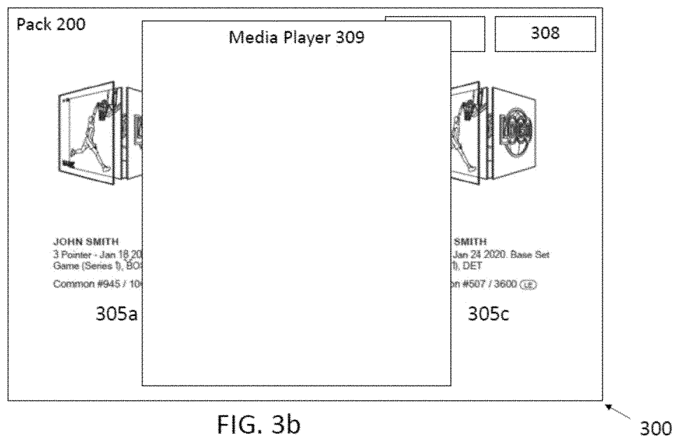

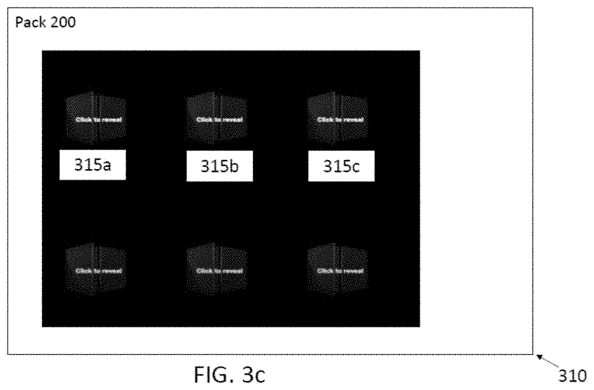

For example, in some embodiments, GUI 300 will display the 3D digital collectibles icons in pack 200 as shown in FIG. 3a. In this example, pack 200 includes three (or other number of) individual 3D digital collectibles. GUI 300 may display the individual 3D digital collectibles icons of pack 200 in any manner. In the FIG. 3a embodiment, each individual 3D digital collectible icon is shown in a grid in a perspective view with a digital media file on one surface and data on the second, but the 3D digital collectibles icon may be shown in any orientation, including any of the orientations discussed above. Individual 3D digital collectibles icons may be arranged in a common orientation, or different orientations. The individual 3D digital collectibles icons may also be arranged in a list or other arrangement that allows a user to view the contents of pack 200.

According to an embodiment, a user may also select one of the 3D digital collectibles icons in pack 200 shown in FIG. 3a. The GUI will then display the selected 3D digital collectible and allow further user interaction, or may launch an interactive GUI such as is described in more detail in a U.S. application filed Apr. 13, 2021 as U.S. application Ser. No. 17/229,430, Attorney Docket No. 77HN-332438, titled “System And Method For Creating, Managing, And Displaying An Interactive Display For 3D Digital Collectibles”, hereby incorporated by reference in its entirety.

The 3D digital collectibles associated with the non-selected icons may not be revealed until the user selects the corresponding icon. A user need not open any pack immediately on purchase. Nor must a user select each of the icons of a pack within a single session. In some embodiments, if a user selects none, one or more, but less than all of the icons in a pack, the 3D digital collectables associated with the non-selected icons will remain unrevealed to the user. However, these 3D digital collectables remain associated with the user account. A GUI associated with the user account profile (and other displays) may display a visual indication of the user's packs, and a visual indication of whether a pack has been opened or not. If a pack is not yet opened, one or more indicators may be presented via a GUI to indicate that pack status. If a pack has been opened, but not all of the 3D digital collectables of the pack have been revealed, one or more indicators may be presented via a GUI to indicate that pack status. Other visual indicators may be displayed to indicate the status of the packs and/or 3D digital collectables within a pack. In some embodiments, if a user selects one or more, but less than all of the icons in a pack, but leaves the pack before selecting the remaining icons, the 3D digital collectables associated with the non-selected icons will automatically be revealed and associated with the user's account.

In some embodiments, media player 309 may automatically play the digital media file in the selected 3D digital collectible. Before, during and/or after the media player starts to play the digital media file, the system may display various data, metadata, context, scarcity indicator and/or other information or content relates to the selected digital collectable. This variety of media and data and the delayed reveal of the digital collectables creating an enjoyable and user experience and can add suspense to the process.

According to another embodiment, a user may request that the digital media files included in the 3D digital collectibles of pack 200 be played in a media player or separate window or pop-up. For example, a user may select the watch button 308 in the FIG. 3a embodiment, which may launch a media player in GUI 300, such as media player 309 in FIG. 3b. Media player 309 is described in more detail in a U.S. application filed Apr. 13, 2021 as U.S. application Ser. No. 17/229,455, Attorney Docket No. 77HN-332439, titled “System And Method For Creating, Managing, And Displaying 3d Digital Collectibles,” hereby incorporated by reference in its entirety.

In an embodiment, media player 309 plays each of the digital media files in the selected (opened) 3D digital collectibles of pack 200 individually and/or in a continuous serial loop, either by sequentially playing the individual digital media files or by stitching together the individual digital media files into one file. In other embodiments, GUI may provide the user options to play particular digital media files, such as by showing individual links or icons, and may allow the user to control the playback.

In another embodiment, after a user selects watch button 308 in FIG. 3a, GUI 300 may sequentially display 3D digital collectibles 305a, 305b, and 305c and their respective digital media files. For example, GUI 300 may display a first 3D digital collectible 305a, automatically play a digital media file from the first 3D digital collectible 305a, then display a second 3D digital collectible 305b and automatically play a digital media file from the second 3D digital collectible 305b, and so on until each 3D digital collectible and digital media file has been displayed in pack 200.

In an embodiment, pack 200 may include a link creation button 307 for a user to create a link to pack 200 to allow other users to view the contents of pack 200. Other buttons, links, or interfaces may be provided.

In another embodiment, a pack 200 may itself include multiple packs of 3D digital collectibles. In such an embodiment, packs, rather than 3D digital collectibles, may be displayed in GUI 300 in FIG. 3a, and another GUI is rendered to display the 3D digital collectibles in the sub-packs. Packs containing sub-packs may be denoted by visual cues, such as shading, highlights, boxes surrounding the individual 3D digital collectibles of a sub-collection.

In another embodiment, the 3D digital collectibles of pack 200 may be hidden after the initial opening of the pack 200, as shown in FIG. 3c. In this embodiment, GUI 310 includes icons (e.g., 305a, 305b, and 305c) that include an indication that clicking on the icon will reveal a 3D digital collectible that is included in the pack. In some embodiments, clicking on an icon will result in the display of the underlying 3D digital collectible, either by replacing the icon 315a with a rendering of the 3D digital collectible (such as is shown in FIG. 3a by collectible 305a), or by making the 3D digital collectible more pronounced in a separate view.

In some embodiments, after an icon 315a is selected and replaced by a digital collectible 305a, digital collectible 305a remains visible. In this manner, by selecting each icon 315a, a view similar to that of FIG. 3b can be provided, where each icon 315a, b, and c is replaced by, for example, 3D digital collectibles 305a, 305b, and 305c. The collectibles may then be interacted with in the manner described above.

In exemplary embodiments, system 410 may include pack manager 429 that creates and manages packs. Pack manager interfaces with rendering engine 418 and display generator 416 to display the packs, intermediate GUI, and underlying 3D digital collectibles in the manner discussed above. Pack manager may assign a unique identifier to each pack. Data related to each pack may be stored as pack data 448. Such data includes relationships between pack identifiers and constituent 3D digital collectibles.

Pack manager 429 may assign 3D digital collectibles to packs. In some embodiments, the 3D digital collectibles may be randomly assigned to packs. In other embodiments, the 3D digital collectibles may be assigned according to data, such as event data, context data, or metadata. In other words, the 3D digital collectibles in a pack may have corresponding context data. For example, in a sports context, the 3D digital collectibles in a pack may each correspond to live entertainment events of a specific league, team, player, moves type, and/or score.

Processing Devices and Processors

In some embodiments, the platforms, systems, media, and methods described herein, including system 400, include a processing devices, processors, or use of the same. In further embodiments, the processing device includes one or more hardware central processing units (CPUs) or general purpose graphics processing units (GPUs) that carry out the device's functions. In still further embodiments, the processing device further comprises an operating system configured to perform executable instructions. In some embodiments, the processing device is optionally connected a computer network. In further embodiments, the processing device is optionally connected to the Internet such that it accesses the World Wide Web. In still further embodiments, the processing device is optionally connected to a cloud computing infrastructure. In other embodiments, the processing device is optionally connected to an intranet. In other embodiments, the processing device is optionally connected to a data storage device. In accordance with the description herein, suitable processing devices include, by way of non-limiting examples, cloud computing resources, server computers, server clusters, desktop computers, laptop computers, notebook computers, sub-notebook computers, netbook computers, netpad computers, handheld computers, mobile smartphones, and tablet computers. In some embodiments, the processing device includes an operating system configured to perform executable instructions. The operating system is, for example, software, including programs and data, which manages the device's hardware and provides services for execution of applications. Those of skill in the art will recognize that suitable server operating systems include, by way of nonlimiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smartphone operating systems include, by way of non-limiting examples, Nokia® Symbian® OS, Apple® iOS®, Research In Motion® BlackBerry OS®, Google® Android®, Microsoft Windows Phone® OS, Microsoft Windows Mobile® OS, Linux®, and Palm® WebOS®. In some embodiments, the processing device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the processing device is not powered. In further embodiments, the non-volatile memory comprises flash memory. In some embodiments, the nonvolatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein. In some embodiments, the processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active matrix OLED (AMOLED) display. In some embodiments, the processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera or other sensor to capture motion or visual input. In still further embodiments, the input device is a combination of devices such as those disclosed herein.

Referring to FIG. 4, in an exemplary platform 400, an exemplary system 410 is programmed or otherwise configured to, for example, dynamically load data provider connector modules and/or request, procure, process, analyze, persist and/or provide one or more data records. In this embodiment, the system 410 includes a processor 412 (also known as a central processing unit (CPU), and “computer processor”), which can be a single core or multi core processor, or a plurality of processors for parallel processing. System 410 also includes memory or memory location (e.g., random-access memory, read-only memory, flash memory), system storage 430 (e.g., hard disk), a communication interface (e.g., network adapter) for communicating with one or more other systems, and peripheral devices, such as cache, other memory, data storage and/or electronic display adapters. The memory, system storage 430, network interface and peripheral devices are in communication with the CPU 412 through a communication bus, such as a motherboard. The system storage 430 can be a data storage unit (or data repository) for storing data. System 410 can be operatively coupled to a computer network (“network”) with the aid of the communication interface. The network can be the Internet, an internet and/or extranet, or an intranet and/or extranet that is in communication with the Internet. The network in some cases is a telecommunication and/or data network. The network can include one or more computer servers, server clusters and/or distributed computing resources, providing, for example cloud computing. The network, in some cases with the aid of the system 410, can implement a peer-to-peer network, which may enable devices coupled to the device 501 to behave as a client or a server.

In some embodiments, the CPU 412 can execute a sequence of machine-readable instructions, which can be embodied in a program or software. The instructions may be stored in a memory location, such as the memory. The instructions can be directed to the CPU 412, which can subsequently program or otherwise configure the CPU 412 to implement methods of the present disclosure. The CPU 412 can be part of a circuit, such as an integrated circuit. One or more other components of the system 410 can be included in the circuit. In some cases, the circuit is an application specific integrated circuit (ASIC) or a field programmable gate array (FPGA).

In some embodiments, the system storage 430 can store files such as drivers, libraries and saved programs. The system storage 430 can store user data, e.g., user preferences and user programs. The system 410 in some cases can include one or more additional data storage units that are external, such as located on a remote server, remote server cluster, network attached storage, or the like, that is in communication through an intranet or the Internet. In some embodiments, methods as described herein can be implemented by way of machine (e.g., computer processor) executable code stored on an electronic storage location of the system 410, such as, for example, on the memory or system storage 430. The machine executable or machine readable code can be provided in the form of software. During use, the code can be executed by CPU 412. In some cases, the code can be retrieved from the system storage 430515 and stored on the memory for ready access by the CPU 412. In some situations, the system storage 430 can be precluded, and machine-executable instructions are stored on memory. In some embodiments, the code is pre-compiled. In some embodiments, the code is compiled during runtime. The code can be supplied in a programming language that can be selected to enable the code to execute in a precompiled or as-compiled fashion.

In some embodiments, the system 410 can include or be in communication with an electronic display 470. In some embodiments, the electronic display 470 provides a user interface or GUI.

Non-Transitory Computer Readable Storage Medium

In some embodiments, the platforms, systems, media, and methods disclosed herein include one or more non-transitory computer readable storage media encoded with a program including instructions executable by the operating system of an optionally networked processing device. In further embodiments, a computer readable storage medium is a tangible component of a processing device. In still further embodiments, a computer readable storage medium is optionally removable from a processing device. In some embodiments, a computer readable storage medium includes, by way of non-limiting examples, CD-ROMs, DVDs, flash memory devices, solid state memory, magnetic disk drives, magnetic tape drives, optical disk drives, distributed computing systems including cloud computing systems and services, and the like. In some cases, the program and instructions are permanently, substantially permanently, semi-permanently, or non-transitorily encoded on the media.

Computer Program

In some embodiments, the platforms, systems, media, and methods disclosed herein include at least one computer program, or use of the same. A computer program includes a sequence of instructions, executable in the processing device's CPU, written to perform one or more specified tasks. Computer readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages. The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof

Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft®.NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language OiML). In some embodiments, a web application is written to some extent in a presentation definition language such as Cascading Style Sheets (CSS). In some embodiments, a web application is written to some extent in a client-side scripting language such as Asynchronous JavaScript and XML (AJAX), Flash® ActionScript, Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of nonlimiting examples, Adobe® Flash®, HTML 5, Apple® QuickTime®, Microsoft® Silverlight®, Java™, and Unity®.

Mobile Application

In some embodiments, a computer program includes a mobile application provided to a mobile processing device. In some embodiments, the mobile application is provided to a mobile processing device at the time it is manufactured. In other embodiments, the mobile application is provided to a mobile processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB .NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, Mobi-Flex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Google® Play, Chrome Web Store, BlackBerry® App World, App Store for Palm devices, App Catalog for webOS, Windows® Marketplace for Mobile, Ovi Store for Nokia® devices, Samsung® Apps, and Nintendo® DSi Shop.

Software Modules

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of nonlimiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

Databases

In some embodiments, the platforms, systems, media, and methods disclosed herein include one or more databases, or use of the same. In view of the disclosure provided herein, those of skill in the art will recognize that many databases are suitable for storage and retrieval of data, such as digital media collectibles described herein. In various embodiments, suitable databases include, by way of non-limiting examples, relational databases, nonrelational databases, object oriented databases, object databases, entity-relationship model databases, associative databases, and XML databases. In some embodiments, a database is web-based. In still further embodiments, a database is cloud computing-based. In other embodiments, a database is based on one or more local computer storage devices.

Various methods have been described herein to generate, maintain, and display 3D digital collectibles, including methods using exemplary steps. It may be understood that more or less steps may be included, and that the illustrated steps are merely non-limiting examples. Nor is the order in which the steps are presented/described indicative of any set or requisite order that must be followed. It should be appreciated that various prompts, cues, buttons, and/or other graphical/visual interactive elements may be presented to the user together with one or more of these steps. _Steps depicted herein may correspond to instructions stored in computer readable storage medium which can be executed by one or more processors of computing components described herein, for example as part of computing components disclosed herein

While the invention has been particularly shown and described with reference to exemplary embodiments thereof, the invention is not limited to these embodiments. It will be understood by those of ordinary skill in the art that various changes in form and details may be made therein without departing from the spirit and scope of the invention as defined by the following claims.

1. A system comprising:
at least one processor; and
a computer-readable storage medium having instructions stored thereupon which are executable by the at least one processor and which, when executed, cause the computing system to perform operations comprising:
generating, according to a stored set of rules, a first graphical user interface comprising a first pack icon representing a first pack of n digital collectibles each to be represented by a different corresponding 3D virtual display element among a first set of n 3D virtual display elements;
generating, in response to selection of the first pack icon at a first time, a second graphical user interface different from the first graphical user interface, the second graphical user interface comprising a set of n element icons that each correspond to a different one of the n 3D virtual display elements of the first pack, wherein a first element icon of the set of n element icons corresponds to a first 3D virtual display element among the first set of n 3D virtual display elements and has a first size, a first shape, and a first appearance that indicates an unrevealed status of a corresponding digital collectible represented by the first 3D virtual display element;
generating, at a second time after the first time and in response to selection of the first element icon of the set of n element icons in the second graphical user interface, the first 3D virtual display element that corresponds to the first element icon, the first 3D virtual display element having a second size larger than the first size of the first element icon, a second shape same as the first shape of the first element icon, and a second appearance different from the first appearance of the first element icon and comprising a first surface that indicates a first digital media file thereon and a second surface that indicates data relating to the first digital media file thereon; and
generating, in response to the selection of the first element icon of the set of n element icons in the second graphical user interface, an updated rendering of the first element icon to have the first size, the first shape, and a scaled-down version of the second appearance different from the first appearance and indicating a revealed status of the corresponding digital collectible represented by the first 3D virtual display element that corresponds to the first element icon.

2. The system of claim 1, wherein the first pack icon representing the first pack is rendered to resemble a physical pack of trading cards.

3. The system of claim 1, wherein the first pack icon representing the first pack includes an indication describing an aspect of one or more of the first set of n 3D virtual display elements.

4. The system of claim 1, wherein the first pack icon representing the first pack includes an indication of a number of 3D virtual display elements in the first set of n 3D virtual display elements.

5. The system of claim 1, wherein the first pack icon representing the first pack includes an indication of a scarcity value of one or more of the 3D virtual display elements in the first set of n 3D virtual display elements.

6. The system of claim 5, wherein the indication of the information scarcity value includes a visual indicator comprising one or more of a color, shading, material, texture, and lighting.

7. (canceled)

8. The system of claim 1, wherein the operations further comprise generating, in response to selection of a second element icon of the set of n element icons in the second graphical user interface, a second 3D virtual display element corresponding to the second element icon.

9. The system of claim 1, wherein the operations further comprise specifying the first set of n 3D virtual display elements associated with the first pack.

10. (canceled)

11. The system of claim 1, wherein the operations further comprise generating, in response to the selection of the first pack icon at the first time, a representation of the first pack icon being torn open.

12. The system of claim 1, wherein the first appearance of the first icon comprises a n-sided 3D shape with blank surfaces.

13. (canceled)

14. (canceled)

15. A method comprising:
generating, by at least one processor and according to a stored set of rules, a first graphical user interface comprising a first pack icon representing a first pack of n digital collectibles each to be represented by a different corresponding 3D virtual display element among a first set of n 3D virtual display elements;
generating, by the at least one processor and in response to selection of the first pack icon at a first time, a second graphical user interface different from the first graphical user interface, the second graphical user interface comprising a set of n element icons that each correspond to a different one of the n 3D virtual display elements of the first pack, wherein a first element icon of the set of n element icons corresponds to a first 3D virtual display element among the first set of n 3D virtual display elements and has a first size, a first shape, and a first appearance that indicates an unrevealed status of a corresponding digital collectible represented by the first 3D virtual display element;
generating, by the at least one processor at a second time after the first time and in response to selection of the first element icon of the set of n element icons in the second graphical user interface, the first 3D virtual display element that corresponds to the first element icon, the first 3D virtual display element having a second size larger than the first size of the first element icon, a second shape same as the first shape of the first element icon, and a second appearance different from the first appearance of the first element icon and comprising a first surface that indicates a first digital media file thereon and a second surface that indicates data relating to the first digital media file thereon; and
generating, by the at least one processor and in response to the selection of the first element icon of the set of n element icons in the second graphical user interface, an updated rendering of the first element icon to have the first size, the first shape, and a scaled-down version of the second appearance different from the first appearance and indicating a revealed status of the corresponding digital collectible represented by the first 3D virtual display element that corresponds to the first element icon.

16. A non-transitory computer-readable medium storing instructions that, when executed by at least one processor, cause the at least one processor to perform operations comprising:
generating, according to a stored set of rules, a first graphical user interface comprising a first pack icon representing a first pack of n digital collectibles each to be represented by a different corresponding 3D virtual display element among a first set of n 3D virtual display elements;
generating, in response to selection of the first pack icon at a first time, a second graphical user interface different from the first graphical user interface, the second graphical user interface comprising a set of n element icons that each correspond to a different one of the n 3D virtual display elements of the first pack, wherein a first element icon of the set of n element icons corresponds to a first 3D virtual display element among the first set of n 3D virtual display elements and has a first size, a first shape, and a first appearance that indicates an unrevealed status of a corresponding digital collectible represented by the first 3D virtual display element;
generating, at a second time after the first time and in response to selection of the first element icon of the set of n element icons in the second graphical user interface, the first 3D virtual display element that corresponds to the first element icon, the first 3D virtual display element having a second size larger than the first size of the first element icon, a second shape same as the first shape of the first element icon, and a second appearance different from the first appearance of the first element icon and comprising a first surface that indicates a first digital media file thereon and a second surface that indicates data relating to the first digital media file thereon; and
generating, in response to the selection of the first element icon of the set of n element icons in the second graphical user interface, an updated rendering of the first element icon to have the first size, the first shape, and a scaled-down version of the second appearance different from the first appearance and indicating a revealed status of the corresponding digital collectible represented by the first 3D virtual display element that corresponds to the first element icon.
